(19) United States
(12) Patent Application Publication
(10) Pub. No.: US 2016/0189304 A1
(43) Pub. Date: Jun. 30, 2016

(54) DETECTION OF USERS AND VEHICLE USAGE FOR VARIABLE INSURANCE TERMS

(71) Applicant: PayPal, Inc., San Jose, CA (US)

(72) Inventors: Michael Charles Todasco, Santa Clara, CA (US); Dennis Michael Driscoll, Chalfont, PA (US); Jeremy Leigh Cattone, San Jose, CA (US); Amit Reuven Menipaz, San Jose, CA (US)

(21) Appl. No.: 14/586,783

(22) Filed: Dec. 30, 2014

(51) Int. Cl. G06Q 40/08

(52) U.S. Cl. CPC G06Q 40/08

(57) ABSTRACT

There are provided systems and methods for detection of users and vehicle usage for variable insurance terms. A user may utilize a vehicle and require an insurance policy for usage of the vehicle. The user may have an existing insurance policy or may require a new insurance policy. Once the user is detected as utilizing the vehicle, usage factors of the vehicle by the user may be communicated to a variable insurance server. Usage factors may include a location of use of the vehicle, speed of travel, a driver history for the user, or other information. The server may determine a new insurance policy for the user or may determine an adjustment to the user's existing insurance policy. Such insurance policy changes may be based on the user, the vehicle, and the user's usage of the vehicle. The user may accept the server's proposal to initiate the change.

### TECHNICAL FIELD

The present application generally relates to detection of users and vehicle usage of variable insurance terms and more specifically to determining new insurance policies and/or changes to existing insurance policies based on vehicle usage information, user information, and/or available insurance policies.

### BACKGROUND

Vehicles may be operated by a plurality of different people, such as an owner of the vehicle, a renter of the vehicle, and/or other operators who loan or are given permission to operate the vehicle. In order to cover damage caused during operation of the vehicle, each user and the vehicle may have an insurance policy that provides insurance coverage of such damage caused to property and/or person. Such insurance coverage may include limits on payout to cover the property and/or personal damage, as well as costs, use restrictions, deductibles, and other terms. However, due to each user's operation of the vehicle, the insurance coverage may not be adequate, the user may be in violation of a term of the insurance coverage, or the insurance coverage may be excessive. For example, each user's driving history may influence a cost of the insurance policy and/or an applicability of the insurance policy to that user (i.e., some users may be prevented or limited in their use of the vehicle based on their driving history). Further, local ordinance may affect each user's insurability and govern their use of the vehicle. However, without becoming aware of the insurance requirements of each user, the vehicle, and the usage of the vehicle, insurance policies may not provide optimized benefits to the operators of the vehicle.

### BRIEF DESCRIPTION OF THE DRAWINGS

FIG. 1 is a block diagram of a networked system suitable for implementing the processes described herein, according to an embodiment;

FIG. 2 is an exemplary environment having users in multiple locations utilizing vehicles with variable insurance policies while traveling on, according to an embodiment;

FIG. 3 is an exemplary system environment having a variable insurance server providing new policies and adjustments to existing policies based on usage of a vehicle by a user, according to an embodiment;

FIG. 4 is a flowchart of an exemplary process for detection of users and vehicle usage for variable insurance terms, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide detection of users and vehicle usage for variable insurance terms. Systems suitable for practicing methods of the present disclosure are also provided.

In various embodiments, a user may operate a vehicle and require insurance coverage for the user's usage of the vehicle, such as an insurance policy covering personal and/or property damage. In various embodiments, the user may own the vehicle. However, the user may also rent the vehicle or borrow the vehicle from a third party. For example, the vehicle may belong to a parent or friend that offers their vehicle for use to an associated person. The vehicle may also belong to a service that provides use of the vehicle to other users, such as a company car, rental vehicle, a fleet vehicle, and/or a car share service. The vehicle may also correspond to vehicles other than a car, such as a boat, motorcycle, airplane, etc. The user may require a new insurance policy for the vehicle or the user may only require a change to an existing insurance policy for the user and/or the vehicle. In various embodiments, the user may require insurance coverage for the user, or the user may require insurance coverage for another user associated with the user (e.g., a child driving a parent's car, two friends sharing a rented car during a vacation, etc.). The insurance may also be adjusted based on a detected condition of the vehicle and/or the vehicle's environment. For example, an insurance policy may be adjusted based on the time of year (e.g., summer/winter) and/or the vehicle's conditions (e.g., winter tires, worn tires/brakes, etc.). The insurance policy may depend or be required based on the type of vehicle, such as car, commuter vehicle, transportation/shipping truck, motorcycle, etc.

The user may request an insurance policy or an adjustment to an existing insurance policy during usage of the vehicle. However, the user may be detected as utilizing the vehicle so that new insurance policies and/or adjustments may be determined. For example, the user may be detected in and/or operating the vehicle by providing some information to a device associated with the vehicle (e.g., a center console computing device or heads up display by providing a log in credential) by entering a log in credential identifying a user account for the user and PIN/password associated with the user account. The user may also be detected through biometrics and biometric reading devices utilized by the vehicle device, such as a fingerprint scanner (e.g., a fingerprint scanner on a door handle, steering wheel, or input device of the vehicle device), eye/retinal scanner, DNA reader, breathalyzer, etc.

The user may also be detected when the vehicle's device connects to a communication device of the user. In such embodiments, the user may have a mobile/smart phone, wearable computing device (e.g., eyeglasses or wristwatch with processing features), tablet computer, or other user device. The vehicle's device and the device of the user's may communicate through a short range communication protocol, such as Bluetooth, WiFi, Bluetooth Low Energy, LTE Direct, infrared, radio, near field, or other communication protocol. The device for the vehicle may correspond to a dashboard or other onboard computing device, or may correspond to a device associated with the user associated with the vehicle, such a mobile/smart phone, tablet computer, wearable computing device, or other device. The device may belong to an owner of the vehicle, rental company/person providing the vehicle to the user, etc. Thus, once the vehicle's device and the user's communication device connect, the user may be identified as operating the vehicle.

Once operation of the vehicle by the user is detected, usage factors, parameters, and/or information may be determined and communicated to a variable insurance server for processing. The usage information may be determined using one or more sensors on the vehicle and/or associated with the vehicle. The usage information may also be entered into a device associated with the user and/or the vehicle. For example, usage information may include information for at least one of a location of travel for the vehicle, a speed of travel for the vehicle, a length of travel/usage of the vehicle, a number of passengers in the vehicle, an age of the passengers in the vehicle, a health state of at least one of the first user and the passengers in the vehicle, cargo transported by the vehicle, a driving history of the user, expected repairs during use of the vehicle by the user, theft information for the location of travel for the vehicle, vehicle information for the vehicle, additional drivers of the vehicle associated with the first user, and legal defense requirements for use of the vehicle by the user. Thus, the usage information may be detected through a speedometer, a length of travel may be detected through an odometer, a number of passengers may be detected through seat/door sensors, etc. Similarly, a location of usage, additional drivers, and/or legal defense requirements may be entered through a device associated with the vehicle. In some embodiments, both the vehicle's sensors and the device may be required to determine the usage information.

Once the usage information is received, the server may access insurance coverage information for the user and user information. The user information may be received from the device associated with the vehicle and/or user, or may be accessed based on known information about owners/renters of the vehicle. The user information may include additional information that may be included in or associated with the usage factors, such as previous driving records/history, an age of the user, a height/weight of the user, the user's location of use of the vehicle, passengers and/or cargo the user transports, etc. The insurance coverage information may include present insurance coverage of the user, which may include an insurance policy of the user in general, an insurance policy of the user with the vehicle, and/or information indicating that the user does not have a present insurance policy generally and/or with the vehicle. The server may also access information about available insurance coverage and/or policies, such as a plurality of available insurance policies. The available insurance policies may be offered by the user or may be sourced from available insurers. For example, the server may act as a marketplace where more than one insurer may offer insurance services to associated users. The insurers may bid to offer their insurance policies and services to the user based on the information about the user's personal information, vehicle usage, and/or vehicle, or the server may determine a more optimized insurance policy for the user.

When determining a more optimized insurance policy for the user, the server may balance the usage information of the vehicle by the user, the user's personal information, and/or the vehicle's information. A more optimized insurance policy may be determined to maximize or improve at least one of a coverage amount for personal and/or property damage, coverage for transported users and/or cargo, and/or coverage based on local ordinances and laws. The policy may also offer dynamic or reduced pricing base on usage of the vehicle, such as safe driving limits/habits. The policy may be reduced if the vehicle is operated in a safe manner, and may increase if the vehicle is operated in an unsafe manner. In various embodiments, a penalty or partial recovery for an insurance claim may be instituted if usage of the vehicle is unsafe, for example, from logged data of the vehicle (e.g., speeding, traveling an unsafe path, using a mobile device, etc.). The more optimized insurance policy may also minimize a cost to the user for the insurance policy (e.g., monthly and/or yearly fees), a deductible, and/or other associated costs. The more optimized insurance policy may include a new policy for the user or may be an adjustment/change to an existing insurance policy. The server may also determine more than one optimized insurance policy, where each insurance policy optimizes or improves a different insurance factor (e.g., cost, coverage, deductible, etc.).

Thus, the new insurance policy and/or the adjustment to the user's existing insurance policy may be communicated to the user, for example, using the vehicle's device or a communication device for the user. The offer may be extended to the user while the user is utilizing the vehicle so that the user may change insurance coverage of the vehicle during operation of the vehicle based on changing usage information of the vehicle by the user. However, if the user is presently operating the vehicle, selection of an insurance option may be unsafe. Thus, the user may pre-select alternative insurance options for contingencies that arise during use of a vehicle (e.g., a child boarding the vehicle, travelling to a snowy area, etc.). Thus, the alternative insurance options may be intelligently selected based on detection of the associated condition. The user may choose to accept the new policy and/or adjustment, where the server provides activation and servicing of the user's insurance policy. The user may also decline the offer from the server and receive another insurance policy or adjustment from the server. If the user declines the offer, another user associated with the vehicle may be alerted to provide overview and/or compliant use of the vehicle by the user.

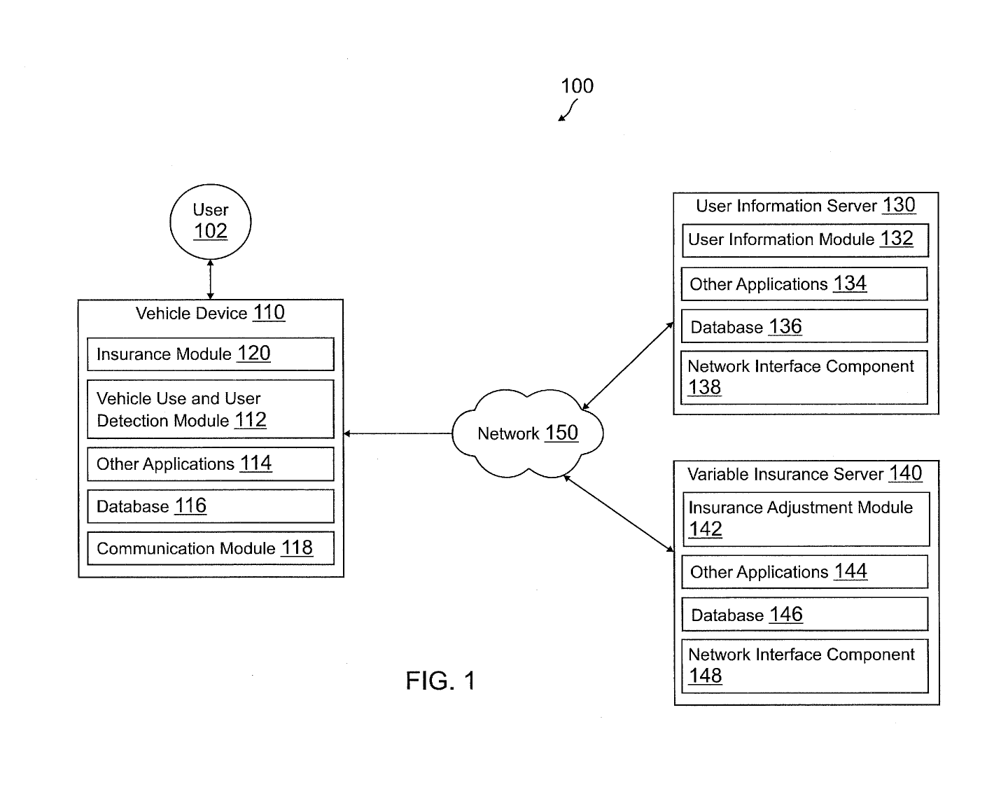

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a vehicle device 110, a user information server 130, and variable insurance server 140 in communication over a network 150. User 102, such as a driver or operator of a vehicle corresponding to vehicle device 110, may be detected and usage information of the vehicle may be tracked by vehicle device 110. The usage information may be communicated to variable insurance server 140 for determination of an adjustment to present insurance coverage. Variable insurance server 140 may determine the adjustment using the usage information of the vehicle by user 102, and may access user information from user information server 130.

Vehicle device 110, user information server 130, and variable insurance server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Vehicle device 110 may be implemented using any appropriate hardware and software configured for wired and/or wireless communication with user information server 130 and/or variable insurance server 140. In various embodiments, vehicle device 110 may be implemented as a device for use in a vehicle corresponding to vehicle device 110, such as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®, which may provide processing services for the vehicle. Vehicle device 110 may also be implemented as a device physically attached to and/or connected to the vehicle, such as a dashboard or central console computing system, a heads up display with attached processing devices, and/or a similar in vehicle on board computing system. Although a vehicle device is shown, the vehicle device may be managed or controlled by any suitable processing device. Although only one vehicle device is shown, a plurality of vehicle devices may function similarly. Moreover, in various embodiments, one or more of the applications, processes, and/or features discussed below in reference to vehicle device 110 may be included in a communication device connected to vehicle device 110. Furthermore, the processes and features of user information module 132 of user information server 130 may be implemented on vehicle device 110 instead.

Vehicle device 110 of FIG. 1 contains an insurance module 120, a vehicle use and user detection module 112, other applications 114, a database 116, and a communication module 118. Insurance module 120, vehicle use and user detection module 112, and other applications 114 may correspond to processes, procedures, and/or applications, for example, a software program, executable by a hardware processor. In other embodiments, vehicle device 110 may include additional or different modules having specialized hardware and/or software as required.

Insurance module 120 may correspond to one or more processes to execute modules and associated devices of vehicle device 110 to receive/access vehicle usage information (e.g., vehicle usage factors and parameters) for the vehicle corresponding to vehicle device 110 and communicate the parameters to variable insurance server 140. In this regard, insurance module 120 may correspond to specialized hardware and/or software utilized by vehicle device 110 to further receive adjustment to insurance coverage for user 102 with the vehicle associated with vehicle device 110, such as new insurance policies and/or adjustment to current insurance coverage, present the adjustments to user 102, and communicate an accept or decline decision of the adjustment by user 102. Thus, insurance module 120 may first determine whether to request an adjustment to insurance coverage from variable insurance server 140. Insurance module 120 may communicate the request to variable insurance server 140 on detection of user 102 using vehicle use and user detection module 112, on detection of vehicle usage information by vehicle use and user detection module 112, and/or through user input by user 102 or a third party, such as a renter or owner of the vehicle. User 102 may be detected in the vehicle using vehicle use and user detection module 112, as will be explained in more detail herein. In other embodiments, insurance module 120 may communicate a request periodically, may communicate a request based on a change in vehicle usage information, or may communicate the vehicle usage information for a determination by variable insurance server 140 of whether an adjustment to insurance coverage is available or necessary.

Thus, insurance module 120 may communicate vehicle usage information, such as at least one factor or parameter for the use of the vehicle associated with vehicle device 110 by user 102, to variable insurance server 140. As will be discussed in more detail herein, the vehicle usage information may be tracked by vehicle use and user detection module 112. Additionally, the vehicle usage information may be entered by user 102 using insurance module 120. In such embodiments, the vehicle usage information may correspond to present or future usage information for the vehicle that user 102 is aware that they will perform. For example, user 102 may be aware of a present location for the vehicle or a destination location. User 102 may also enter information about health issues for one or more users in the vehicle, cargo that the vehicle may be transporting, time of day, month, or year user 102 may utilize the vehicle, present weather conditions (e.g., weather that may not be detectable or accessible through vehicle device 110 and/or variable insurance server 140), user information (e.g., age, weight, height, gender, etc.), a desired travel route, a type of vehicle, passengers to transport in the vehicle, potential repair costs, potential gas costs, a driver history for user 102, legal defense requirements for user 102, and/or other usage information that user 102 may have. Cargo and other persons or items transported by a vehicle may also be detected through attached information (e.g., a barcode, NFC, RFID, etc.) that may reference the cargo/person and/or their applicable insurance requirements. The insurance requirements may be satisfied by an existing policy or may require a specific policy available for purchase. Thus, the information may be scanned by the user or automatically detected in the vehicle by a device. In various embodiments, the vehicle usage information may also be entered by a third party associated with the vehicle, such as a renter, insurer, and/or owner of the vehicle. Further, information about surrounding vehicles may be made available to variable insurance server 140, where user 102 may set acceptable risk limitations or thresholds with variable insurance server 140. Thus, if a vehicle nearby user 102 is uninsured or underinsured, variable insurance server 140 may determine whether user 102's policy may require adjustment based on the other vehicle and user 102's acceptance of risk.

After communication of vehicle usage information to variable insurance server 140, variable insurance server 140 may determine an adjustment to current insurance coverage for user 102, as will be explained in more detail herein. The adjustment may be communicated to vehicle device 110 and displayed to user 102, such as through a display interface having one or more display hardware components. The display interface may allow user 102 to view the adjustment to user 102's insurance coverage. The adjustment may include a new insurance policy having new terms or a change of a current insurance policy terms. Thus, insurance module 120 may also display present insurance coverage for user 102 prior to acceptance of the adjustment through the display interface. The present insurance coverage may assist user 102 in viewing changes to existing policies/terms. If user 102 does not have present coverage, insurance module 120 may alert user 102 of user 102's lack of coverage. Vehicle device 110 and/or variable insurance server 140 may also alert a second user, such as a third party renter, owner, etc., of user 102's present insurance coverage and/or the adjustment to the insurance coverage. Such alerts may be communicated to a communication device (e.g., a mobile phone, tablet computer, personal computer, wearable computing device, etc.) of the third party for their review.

Insurance module 120 may further include processes to accept or decline the adjustment of user 102's insurance coverage. If user 102 accepts the adjustment, the decision to accept may be communicated to variable insurance server 140 in order to initiate the new insurance policy or perform the changes to the existing insurance policy. However, if user 102 declines the adjustment, the decision may similarly be communicated to variable insurance server 140, which may offer a new adjustment or inform user 102 of user 102's risks for not accepting the insurance coverage adjustment. Insurance module 120 may present further communications from variable insurance server 140 to user 102 and allow user 102 to decide whether to request a second or further insurance coverage adjustment. The accept or decline decision may also be communicated by vehicle device 110 and/or variable insurance server 140 to the second user (e.g., the third party renter, owner, etc.) to alert the third party of user 102's decision and allow the third party to take appropriate action.

Vehicle use and user detection module 112 may correspond to one or more processes to execute modules and associated specialized hardware of vehicle device 110 to detect user 102 as in, nearby, or otherwise using a vehicle associated with vehicle device 110 and track/determine vehicle usage information for user 102's use of the vehicle. In this regard, vehicle use and user detection module 112 may correspond to specialized hardware and/or software utilized by vehicle device 110 to first detect that user 102 is operating or attempting to operate the vehicle and may require an adjustment to user 102's insurance coverage. In order to detect user 102, vehicle use and user detection module 112 may utilize one or more sensors, such as a door sensor, weight sensor, pressure sensor, key detector or ignition switch, biometric scanner, log in process, device connection/communication module, and/or proximity sensor. For example, user 102 may be detected when user 102 opens a door to utilize the vehicle, sits in a seat associated with the vehicle, or places a key in an ignition or in proximity to the vehicle. Once user 102 is detected as in or nearby the vehicle, vehicle use and user detection module 112 may determine usage information for user 102's usage of the vehicle and provide the usage information to insurance module 120, as previously discussed. In various embodiments, an identity for user 102 may already be associated with vehicle device 110. However, in other embodiments, vehicle user and user detection module 112 may be required to identify user 102 or request identification of user 102 when user 102 is detected as operating the vehicle.

Vehicle use and user detection module 112 may detect user 102 and/or determine an identification for user 102 by detecting and connecting with a device associated with user 102 and receiving identification information for user 102 (e.g., a name, identifier, etc.). As previously discussed, vehicle device 110 may be located in, attached and connected to, and/or associated with a vehicle. User 102 may utilize a communication device (e.g., a mobile/smart phone, laptop or tablet computer, wearable computing device, or other device) to connect to vehicle device 110 in order to provide identification information to vehicle device 110. The connection between the user device and vehicle device 110 may utilize short range wireless communications of vehicle device 110 to establish the connection. For example, vehicle use and user detection module 112 may transmit an identifier such as a Universally Unique Identifier (UUID) to the device. If user 102's device receives a request to establish the connection with vehicle device 110 and responds with an identifier for user 102, vehicle device 110 to ramp up in power and create a connection between user 102's device and vehicle device 110. The identifier for vehicle device 110 transmitted to user 102's device may be included in the received identifier for user 102 and/or user 102's device. For example, the identifier may be transmitted with, concatenated with, or otherwise bundled with the identifier in the received token. In such embodiments, vehicle use and user detection module 112 may utilize communication module 118 of vehicle device 110 to receive the token from user 102's device, and process the token to establish a connection and determine an identity for user 102. In various embodiments, vehicle use and user detection module 112 may execute in the background of an operating system of vehicle device 110 and be configured to establish connections, using communication module 118 of vehicle device 110, with user 102's device. However, in other embodiments, vehicle use and user detection module 112 may connect with user 102's device on command by user 102.

Thus, vehicle device 110 may uniquely transmit the request to establish the connection with vehicle device 110 as a short range wireless communication (e.g. a BLE protocol communication) including a “wake up” process for user 102's device and a token for vehicle device 110 transmitting the request. In other embodiments, the request and/or connection may utilize near field communication, radio communication, infrared communication, or Bluetooth communication. Additionally, although vehicle device 110 may utilize BLE protocol communications to effectuate an “always on” type service where the UUID and “wake up” process are transmitted continuously by vehicle device 110, other communication protocols used to provide an “always on” service may include QUALCOMM® LTE Direct or similar device-to-device communication technology. BLE and LTE Direct may both be utilized to provide discovery of nearby devices to vehicle device 110 and establishment of a connection for identification of user 102.

In various embodiments, vehicle device 110 may also request a log in from user 102 that detects and identifies user 102, for example, using an input device and interface associated with vehicle device 110 (e.g., an input interface of a display module for vehicle device 110, and/or the aforementioned input interface of insurance module 120). In such embodiments, user 102 may provide an identifier, user account name, password, and/or PIN directly to vehicle device 110 without the use of the aforementioned device in possession of user 102. Once user 102 logs in to vehicle use and user detection module 112, an identity of user 102 may be accessed (e.g., from database 116) or determined using vehicle user server 130 or another service provider.

User 102 may also be detected and/or identified by vehicle use and user detection module 112 using biometrics and biometric reading devices utilized by vehicle device 110, such as a fingerprint scanner (e.g., a fingerprint scanner on a door handle, steering wheel, or input device of the vehicle device), eye/retinal scanner, DNA reader, breathalyzer, etc. Once a biometric reading of user 102 is received by vehicle use and user detection module 112, vehicle use and user detection module 112 may determine an identity of user 102 through accessing identification information associated with the biometric read to one or more of database 116 and/or user information server 130. Thus, identification information may be entered to vehicle using an interactive touch screen, a keyboard, a mouse, a biometric reader, or other input device for vehicle device 110. The identification information may further be stored with information for user 102, such as the identifier for user 102, the log in information of user 102, and/or the biometric reading of user 102.

Once user 102 is detected by vehicle use and user detection module 112, vehicle use and user detection module 112 may track and/or determine vehicle usage information for user 102's use of the vehicle associated with vehicle device 110. For example, if user 102 has previously been using the vehicle, vehicle use and user detection module 112 may access user 102's usage factors and/or parameters of the vehicle from database 116. Further, if user 102 wishes to continue or begin operation of the vehicle, vehicle use and user detection module 112 may track user 102's further use. As previously discussed, certain usage information may be entered to insurance module 120. However, vehicle use and user detection module 112 may also access sensors, databases, and other resources to detect user 102's past, present, and/or future usage information for the vehicle. Such sensors may correspond to vehicle travel sensors, such as a speedometer, odometer, temperature sensor, barometer, engine sensor (e.g., RPM gauge, engine temperature gauge, oil level sensor, radiator sensor, etc.), or other sensor associated with vehicle use and travel. Sensors may also be associated with users inside the vehicle, such as door sensors, seat sensors, eye/movement sensors, interior temperature sensors, etc.

Vehicle use and user detection module 112 may also track user 102's use of associated applications and services of vehicle device 110 while operating the vehicle, such as use of messaging, mapping, or communication applications/services while driving the vehicle. Vehicle use and user detection module 112 may also track user 102's driving state and/or actions, such as lane changes, acceleration/deceleration, use of indicators and proper lighting, etc. Vehicle use and user detection module 112 may track the vehicle's maintenance state and/or maintenance wear caused by user 102's usage of the vehicle. Thus, vehicle use and user detection module 112 may track information required to determine one or more of a location of travel for the vehicle, a speed of travel for the vehicle, a number of passengers in the vehicle, an age of the passengers in the vehicle, a health state of at least one of the first user and the passengers in the vehicle, cargo transported by the vehicle, a driving history of the user, unsafe driving actions taken by the user, expected repairs during use of the vehicle by the user, theft information for the location of travel for the vehicle, vehicle information for the vehicle, additional drivers of the vehicle associated with the first user, and legal defense requirements for use of the vehicle by the user. As previously discussed, such information may be utilized by insurance module 120 for communication to variable insurance server 140.

In various embodiments, one or more features of insurance module 120 and/or vehicle use and user detection module 112 may be incorporated in the same module so as to provide their respective features in one module.

Vehicle device 110 includes other applications 114 as may be desired in particular embodiments to provide features to vehicle device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow an owner/operator of a vehicle corresponding to vehicle device 110 to send and receive emails, calls, texts, and other notifications through network 150. Such communication applications may also correspond to mobile, satellite, wireless Internet, and/or radio communication applications connected to car services, such as OnStar®, which may be configured to interact with one or more other vehicle devices functioning similar to vehicle device 110 in order to facilitate mapping, communication, and/or emergency services. Other applications 114 may include payment applications and/or services, for example, applications/services that may provide payments for car servicing and/or cleaning, purchases made by user 102 (e.g., food purchases), and/or tolls, gas, or other travel payments required during use of the vehicle. Other applications 114 may include mapping and/or GPS applications configured to display location information to user 102. In various embodiments, other applications 114 may include financial applications, such as banking, online payments, money transfer, or other financial applications. Other applications 114 may contain other software programs, executable by a processor, including a graphical user interface (GUI) configured to provide an interface for vehicle device 110 to the user.

Vehicle device 110 may further include database 116 which may include, for example, identifiers such as operating system registry entries, cookies associated with insurance module 120, vehicle use and user detection module 112, and/or other applications 114, identifiers associated with hardware of vehicle device 110, or other appropriate identifiers, such as identifiers used for payment/user/device authentication or identification. Database 116 may store identification information for one or more users, including user 102, as well as information necessary to access or determine the identification information when user 102 utilizes the vehicle associated with vehicle device 110 (e.g., a identifier, log in information, a biometric reading, etc.). Database 116 may store user 102's vehicle usage information, such as factors and parameters associated with user 102's use of the vehicle. Additionally, received insurance coverage adjustments may be stored to database 116 as well as user 102's accept or decline decision.

Vehicle device 110 includes at least one communication module 118 adapted to communicate with user information server 130, variable insurance server 140, and/or a device for user 102. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with user 102's device using short range communications, such as Bluetooth Low Energy, LTE Direct, radio frequency, infrared, Bluetooth, and near field communications,

User information server 130 may be maintained, for example, by a service provider, which may store, manage, and provide user information for user 102 to one or more of vehicle device 110 and/or variable insurance server 140. For example, user information server 130 may correspond to a personal server, payment provider, user account provider, or other service provider that includes user information for user 102. In this regard, user information server 130 includes one or more processing applications which may be configured to interact with vehicle device 110 and/or variable insurance server 140 to provide stored user information for use in determining an insurance coverage adjustment for user 102. Although only one server is shown, a plurality of servers and/or associated devices may function similarly. Although user information server 130 is described as a server device, in various embodiments, user information server 130 may function as a specialized device for user 102 (e.g., a personal computing device, etc.). Thus, although user information server 130 is shown as separate from vehicle device 110, the below described modules, hardware, and functions may be included within vehicle device 110.

User information server 130 of FIG. 1 includes a user information module 132, other applications 134, a database 136, and a network interface component 138. User information module 132 and other applications 134 may correspond to executable processes, procedures, and/or applications with associated hardware. In other embodiments, user information server 130 may include additional or different modules having specialized hardware and/or software as required.

User information module 132 may correspond to one or more processes to execute modules and associated devices of user information server 130 to receive, store, manage, and/or provide user information associated with user 102. In this regard, user information module 132 may correspond to specialized hardware and/or software utilized by user information server 130 to receive user information, such as user personal and/or financial information. Such information may be associated with a weight, height, health status, age, gender, or other personal trait. User information may also correspond to information for a driving history, previous accidents, previous legal proceedings, or other vehicle history information. Thus, in certain embodiments, user information server 130 may be associated with a past or present insurer. User information module 132 may also receive information about user 102's expected vehicle usage, such as associated passengers, cargo, use of one or more vehicles, expected travel routes, expected travel times (e.g., time of day, week, month, and/or year), or other potential vehicle usage. In such embodiments, user information server 130 may be associated with an employer of user 102. Additionally, user information module 132 may receive and/or store information used to identify user 102 when user 102 is detected as utilizing a vehicle, such as user/device identifiers, log in information for a user account, and/or biometric information for user 102. User information module 132 may then access and/or communicate such information to vehicle device 110 and/or variable insurance server 140 for use when determining an insurance coverage adjustment for user 102.

In various embodiments, user information server 130 includes other applications 134 as may be desired in particular embodiments to provide features to user information server 130. For example, other applications 134 may include security applications for implementing server-side security features, programmatic server applications for interfacing with appropriate application programming interfaces (APIs) over network 150, or other types of applications. Other applications 134 may contain software programs, executable by a processor, including a graphical user interface (GUI), configured to provide an interface to a user.

User information server 130 may further include database 136 which may include, for example, identifiers such as operating system registry entries, cookies associated with restrictions application 132 and/or other applications 134, identifiers associated with hardware of user information server 130, or other appropriate identifiers. Database 136 may include user information, such as driving information about user 102 and/or expected vehicle usage information for user 102. Additionally, database 136 may further include identification information for user 102, as well as identifiers for user 102, a device for user 102, and/or an account for user 102. Database 136 may store log in information and/or biometric information for user 102.

User information server 130 includes at least one network interface component 138 adapted to communicate with vehicle device 110 and/or variable insurance server 140 over network 150. In various embodiments, network interface component 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Variable insurance server 140 may be maintained, for example, by a service provider, which may determine and provide insurance coverage adjustments for user 102 based on receive vehicle usage information for a vehicle associated with vehicle device 110 and utilized by user 102. For example, variable insurance server 140 may correspond to one or more insurance providers, a marketplace offering insurance services from a plurality of insurance providers, and/or a service provider offering insurance adjustment services to users. In this regard, variable insurance server 140 includes one or more processing applications which may be configured to interact with vehicle device 110 and/or user information server 130. In one example, variable insurance server 140 may be provided by EBAY®, Inc. of San Jose, Calif., USA. Although only one server is shown, a plurality of servers and/or associated devices may function similarly. Although variable insurance server 140 is described singly, in various embodiments a plurality of variable insurance servers may function similarly.

Variable insurance server 140 of FIG. 1 includes an insurance adjustment module 142, other applications 144, a database 146, and a network interface component 148. Insurance adjustment module 142 and other applications 144 may correspond to processes, procedures, and/or applications, for example, a software program, executable by a hardware processor. In other embodiments, variable insurance server 140 may include additional or different modules having specialized hardware and/or software as required.

Insurance adjustment module 142 may correspond to one or more processes to execute modules and associated devices to process receive vehicle usage information with user information and/or current insurance coverage information for user 102 to determine an adjustment to user 102's insurance coverage for a vehicle associated with vehicle device 110. In this regard, insurance adjustment module 142 may correspond to specialized hardware and/or software utilized by insurance adjustment module 142 to receive vehicle usage information from vehicle device 110. As previously discussed, vehicle usage information may include information about user 102's usage of the vehicle associated with vehicle device 110 or other information that may associated with user 102's operation of the vehicle (e.g., user 102's past driving history, legal defense requirements while operating the vehicle, other passengers/cargo user 102 may insure, etc.). When receiving the vehicle usage information, user 102 may be presently operating the vehicle or may be operating the vehicle at some future point. Further, user 102 may have previously operated the vehicle and may continue operation of the vehicle such that vehicle usage information corresponds to past vehicle usage by user 102 that may affect future insurance coverage statuses and terms.

Insurance adjustment module 142 may further access user information that may include vehicle usage information as well as additional information that may be utilized to determine insurance coverage for user 102. As previously discussed, user information may include personal (e.g., height, weight, gender, health, etc.) and financial (e.g., financial status, credit rating, amount payable for an insurance premium, amount payable for an insurance deductible, insurability decisions, etc.) information, for example, from vehicle device 110 and/or user information server 130. User information may include the aforementioned vehicle usage information, such as a driving history for user 102.

Once vehicle usage information and/or user information is received/accessed by insurance adjustment module 142, insurance adjustment module may access current insurance policy/coverage information for user 102. Insurance adjustment module 142 may further access available insurance policy/coverage information for a plurality of available insurance policies that variable insurance server 140 may offer to one or more users. For example, insurance adjustment module 142 may access insurance policies offered by one or more insurance providers. Insurance adjustment module 142 may accrue the insurance policy information from the insurance provider(s) through requesting insurance policy information from the insurance provider(s), or insurance adjustment module 142 may allow each insurance provider to submit information or bid on offers to sell the insurance provider's policies. The insurance policy information may include information for each insurance policy, such as coverage amounts, coverage damage types, payable premiums, fees, deductibles, etc. For example, current insurance coverage information for user 102 may include an amount user 102 is insured for when causing damage to person or property, a premium payable to receive such insurance, and a deductible amount. Current insurance information may also include the vehicle(s) that user 102 is insured to operate as well as other people user 102 has insured.

Using the vehicle usage information, the user information, the current insurance coverage information for user 102, and/or the available insurance policy information, insurance adjustment module 142 may determine an adjustment to user 102's current insurance coverage information. As previously discussed, the adjustment may include a new insurance policy where user 102 does not have a present insurance policy. Thus, the adjustment may include an insurance policy having terms for payment, coverage, and other information. The adjustment may also constitute another insurance policy where user 102 has a present insurance policy but insurance adjustment module 142 may offer an entirely new or different insurance policy (e.g., an insurance policy with another insurance provider). The adjustment may also include a change of terms to a present insurance policy, such as an increase or decrease in coverage amounts, premium amounts, and/or deductible amounts, types of coverage, terms of coverage, and/or covered vehicle operators, passengers, and/or cargo.

Insurance adjustment module 142 may determine the adjustment based on insurance coverage needs, expected needs, and/or changes caused by user 102's operation of the vehicle associated with vehicle device 110. Insurance adjustment module 142 may also determine the adjustment based on usage of the vehicle, such as a length of time of operation of a vehicle. Thus, an insurance policy may increase or decrease based on a length of time or other usage factor of the vehicle. For example, user 102 may engage in dangerous driving behavior that increases a likelihood of an accident. Thus, insurance adjustment module 142 may suggest or require additional insurance coverage for user 102 in the adjustment. In other embodiments, user 102 may travel to a location where local ordinances/laws require certain insurance coverage. User 102 may also transport cargo or passengers in the vehicle that may require additional coverage to insure the safety of the passengers/cargo or to surrounding drivers (e.g., a petroleum tanker vehicle may require additional insurance when full as to when empty). The insurance coverage may be specific to the vehicle or to user 102 such that where operators of the vehicle may change, additional insurance may be required.

Once the adjustment is determined by insurance adjustment module 142, the adjustment may be communicated to vehicle device 110 for presentation to user 102 as previously discussed. In various embodiments, a plurality of adjustments may be determined by insurance adjustment module 142 and communicated to vehicle device 110 at the same time. The adjustment may also be communicated to a third party corresponding to the vehicle associated with vehicle device 110. If user 102 (or the third party) accepts the adjustment, insurance adjustment module 142 may receive the decision and process the decision to provide insurance coverage for user 102 that is consistent with the adjustment. However, if user 102 decides to decline the adjustment, insurance adjustment module 142 may determine another adjustment based on the vehicle usage information, user information, current insurance coverage, and/or available insurance policy information. The further adjustment(s) may be determined based on information entered by user 102, such as a maximum price for a premium or deductible, a required insurable amount or coverage type, or additional vehicle usage information.

In various embodiments, variable insurance server 140 includes other applications 144 as may be desired in particular embodiments to provide features to variable insurance server 140. For example, other applications 144 may include security applications for implementing server-side security features, programmatic server applications for interfacing with appropriate application programming interfaces (APIs) over network 150, or other types of applications. Other applications 144 may contain software programs, executable by a processor, including a graphical user interface (GUI), configured to provide an interface to a user.

Additionally, variable insurance server 140 includes database 146. As previously discussed, user 102 and/or a third party corresponding to a vehicle associated with vehicle device 110 may establish one or more insurance accounts with variable insurance server 140. User accounts in database 146 may include user information, such as name, address, birthdate, payment/funding information, additional user financial information, and/or other desired user data, such as current insurance coverage information for the user/entity. Account holders may link to their respective accounts through a user and/or device identifier. Thus, when an identifier is transmitted to variable insurance server 140, e.g. from vehicle device 110 and/or user information server 130, an account may be found. In other embodiments, user 102 and/or the third party may not have previously established an account and may provide other information to variable insurance server 140 to determine adjustment to current insurance coverage, as previously discussed. Additionally, database 146 may store received information, such as vehicle usage information, user information, current insurance coverage, and/or available insurance policies with one or more insurance providers.

In various embodiments, variable insurance server 140 includes at least one network interface component 148 adapted to communicate vehicle device 110 and/or user information server 130 over network 150. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

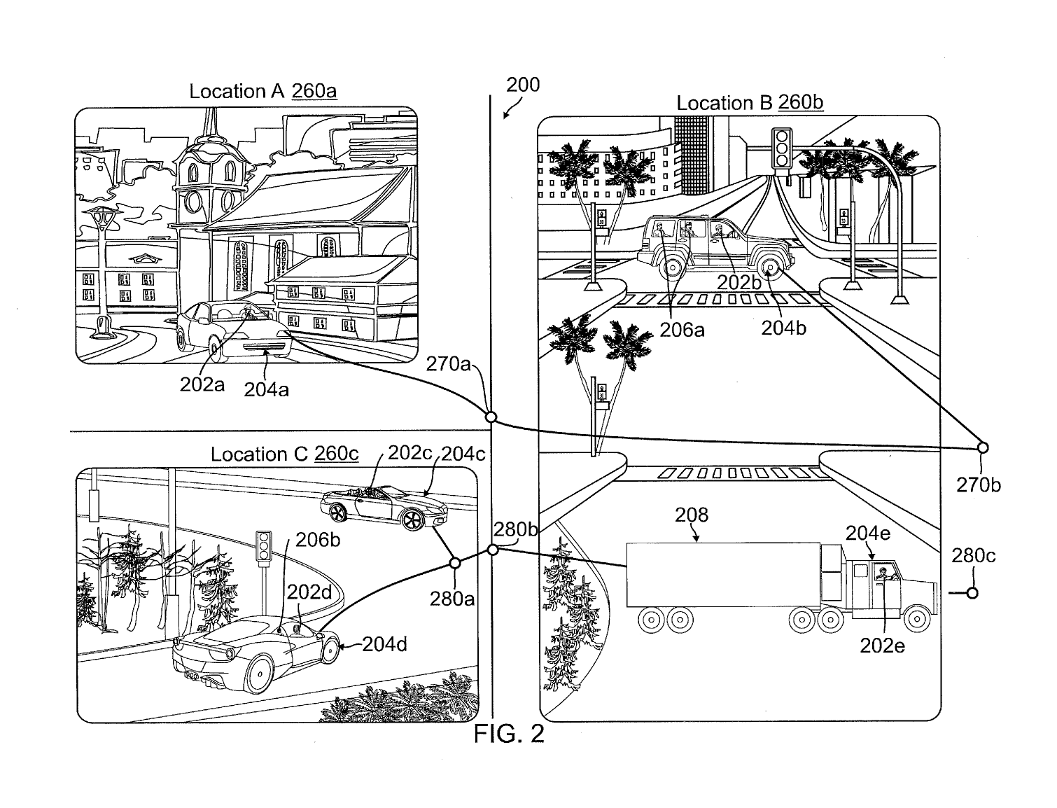

FIG. 2 is an exemplary environment having users in multiple locations traveling in vehicles with variable insurance policies, according to an embodiment. Environment 200 of FIG. 2 includes a user 202a, a user 202b, a user 202c, a user 202d, and a user 202e all corresponding generally to user 102 of FIG. 1, such as an operator of a vehicle 204a, a vehicle 204b, a vehicle 204c, a vehicle 204d, and a vehicle 204e, which includes or has an associated vehicle device corresponding generally to vehicle device 110 of FIG. 1.

Users 202a-e travel in vehicles 204a-e, respectively, through a location A 260a, a location B 260b, and a location C 260c, where each of users 202a-e may encounter different vehicle operation situations, transportable cargo/persons, local laws/ordinances, and/or other vehicle usages where each user's insurance coverage requirements or suggestions may change based on each of users 202a-e's vehicle usage. For example, user 202a operating vehicle 204a may be located in a first town/city where local laws require user 202a to have sufficient coverage to insure at least $50,000 worth of property damage. Thus, while in location A 260a, user 202a's requirements for usage of vehicle 204a may be communicated to a server that may determine whether an adjustment to user 202a's insurance coverage is necessary, and communicate such an adjustment when necessary. Such coverage may be necessary until user 202a arrives at an endpoint 270a in vehicle 204a, which is located on a boundary of location A 260a. As user 202a exits location A 260a in vehicle 204a and travels to location B 260b, the change in vehicle usage (e.g., the change in the local insurance laws) may change for user 202a and/or vehicle 204a and a new adjustment to user 202a's insurance coverage may be determined that corresponds to location B 260b that user 202a will now be operating vehicle 204a in. For example, user 202a may only require $25,000 of property damage coverage while travelling to an endpoint 270b in location B 260b. Thus, as user 202a travels to endpoint 270b, the change in vehicle usage may be communicated to a server, which may optimize user 202a's insurance coverage to reduce coverage amount and likely a premium payment amount. Other vehicle usage may change user 202a's required or suggested insurance coverage and/or terms. Weather condition changes between user 202a's travel to endpoint 270a and endpoint 270b, traffic conditions, user 202a's driving safety, speed/length of travel, and/or time of travel may all increase or decrease required insurance coverage, premiums to be paid, and/or deductible amounts.

Similarly, user 202b operates a vehicle 204b in location B 260b and may be required to obtain adequate insurance coverage for user 202b's operation of vehicle 204b. As user 202b travels to endpoint 270b in location B 260b, user 202b may obtain the same or similar coverage to user 202a while user 202a travels from endpoint 270a to endpoint 270b. However, as shown in environment 200 of FIG. 2, user 202b may be operating a large vehicle with passengers 206a (e.g., a recreational vehicle, bus, truck, or other transportation vehicle user 202b may travel with passengers 206a). Thus, based on detection of passengers 206a in vehicle 204a, user 202b's usage of vehicle 204b may change (e.g., user 202b is now transporting passengers 206a). As such, requirements and/or suggestions for user 202b's insurance coverage based on the size of vehicle 204b and/or the number, health, age, and/or type of passengers 206a. As a server receives such vehicle usage information, the server may determine an adjustment to user 202b's insurance coverage, for example, to cover the size or type of vehicle for vehicle 204b and/or passengers 206a. In various embodiments, user 202b may not own vehicle 204b and instead be renting vehicle 204b for a vacation. Thus, user 202b may be required to obtain insurance in order to operate vehicle 204b. In such embodiments, detection of user 202b in vehicle 204b and user 202b's vehicle usage information for vehicle 204b may be communicated to a server in order to adjust user 202b's current insurance coverage or obtain a new insurance policy for user 202b's use of vehicle 204b. As user 202b arrives at endpoint 270b, detection of user 202b's arrival may be communicated to the server in order to end insurance coverage or offer different insurance coverage.

In location C 260c, user 202c operates vehicle 204c while travelling to an endpoint 280a and an endpoint 280b. Similarly, a user 202d operates vehicle 204d while travelling to endpoint 280a and endpoint 280b. As previously discussed, various vehicle usage of user 202c with vehicle 204c (e.g., driving behavior, speed, travel distance/time, cargo in vehicle 204c, local laws of location C 260c, etc.) may be communicated to a server in order to determine an adjustment to insurance coverage for user 202c with vehicle 204c. Similarly, user 202d's usage of vehicle 204d may be communicated to the server to determine an adjustment. However, as shown in location C 260c, user 204d travels with a passenger 206b in vehicle 204d. Thus, an adjustment for user 202d may be different for user 202d based on the variance in vehicle usage information for user 202d based on travelling with passenger 206b.

As users 202c and 202d travel from endpoint 280b to an endpoint 280c in location B 260b, a user 202e operating a vehicle 204e may travel on the same travel route carrying cargo 208. Cargo 208 may correspond to hazardous materials that may change the vehicle usage information for users 202c and 202d and thus insurance coverage requirements, premiums, deductibles, or other insurance terms for user 202c and 202d while travelling nearby or with user 202e. Furthermore, based on the operation of vehicle 204e on the same travel route, the vehicle usage information may include information about traffic, nearby vehicle types, etc., that may similarly change insurance terms. Thus, an adjustment communicated to users 202c and 202d while travelling to endpoint 280c in location B 260b may include changes to insurance coverage terms based on user 202e, vehicle 204e, and/or cargo 208. Additionally, user 202e's vehicle usage information may include information about cargo 208 that may affect insurance coverage terms for user 202e. For example, cargo 208 may include the aforementioned hazardous materials that require additional insurance, or may include high value items, low value items, an empty cargo hold, or other status that may adjust insurance coverage information.

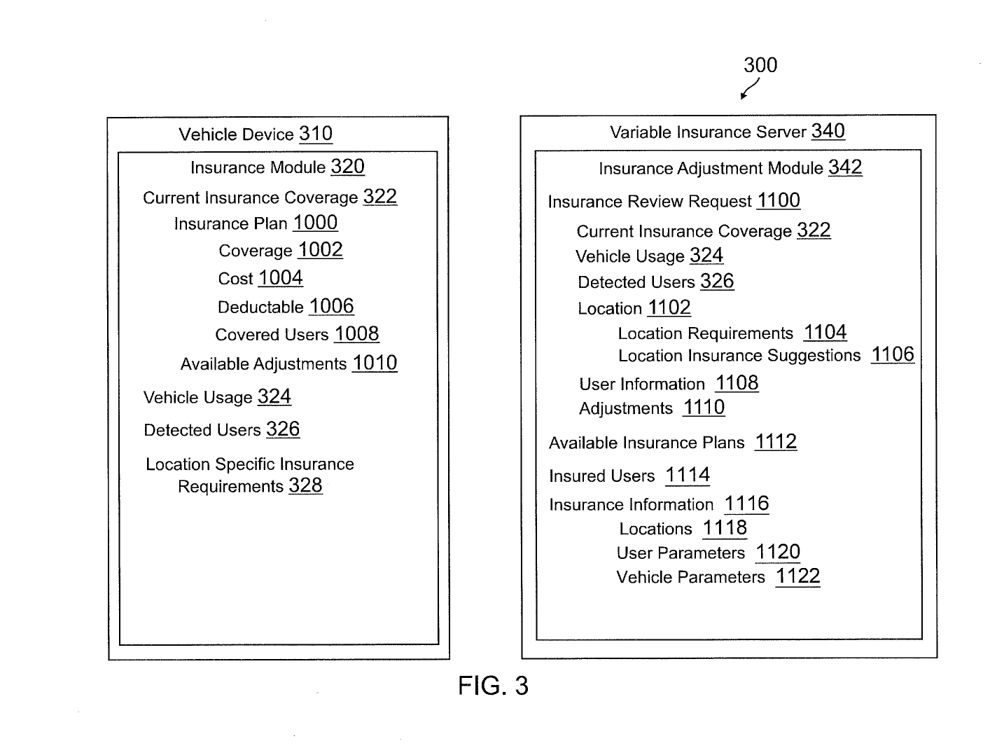

FIG. 3 is an exemplary system environment having a variable insurance server providing new policies and adjustments to existing policies based on usage of a vehicle by a user, according to an embodiment. Environment 300 of FIG. 3 includes a vehicle device 310 and a variable insurance server 340 corresponding generally to vehicle device 110 and variable insurance server 140, respectively, of FIG. 1.

Vehicle device 310 executes an insurance module 320 corresponding generally to the specialized hardware and/or software modules and processes described in reference to insurance module 120 of FIG. 1. In this regard, insurance module 320 may be utilized to provide insurance coverage adjustments for a user (not shown) of a vehicle (not shown) associated with vehicle device 310. Insurance module 320 may include an output device/interface that may display received information to the user. For example, insurance module 320 includes displayable information for current insurance coverage 322, vehicle usage 324, detected users 326, and location specific insurance requirements 328. Current insurance coverage 322 may include a present insurance policy or coverage that the user, such as an insurance plan 1000 having coverage 1002 information (e.g., types of damage covered), a cost 1004 (e.g., a premium cost payable to obtain insurance plan 1000), a deductible 1006 (e.g., an amount required to pay prior to insurance coverage), and covered users 1008 (e.g., users covered under insurance plan 1000). Current insurance coverage 322 may also include information for available adjustments 1010, which may include information for changes to existing insurance policy terms and/or new insurance policies offered to the user. Further insurance module 320 may include information transmittable to variable insurance server 340 and for use in determining available adjustments 1010 under vehicle usage 324 (e.g., vehicle usage information, such as factors of usage and/or other usage parameters) and detected users 326. Insurance module 320 may also include information that may assist the user in determining whether to accept available adjustments, such as location specific insurance requirements 328.

After receiving information from vehicle device 310 (e.g., vehicle usage 324 and detected users 326), insurance adjustment module 342 may determine available adjustments 1010. For example, insurance adjustment module 342 may include specialized hardware and/or software modules and processes described in reference to insurance adjustment module 142 of FIG. 1. In this regard, insurance adjustment module 342 may be utilized to process insurance review request 1100 using available insurance plans 1112, insured users 1114, and insurance information 1116. Insurance review request 1100 may be received based on a request by the user of vehicle device 110, or may be submitted on vehicle device detecting one or more of vehicle usage 324 and detected users 326. Insurance review request 1100 includes current insurance coverage 322 from vehicle device 310, which may be accessed from vehicle device 310 and/or insured users 1114. Further, insurance review request 1100 includes vehicle usage 324 and detected users 326 from vehicle device 310. Insurance review request 1100 may also include a location 1102 for the vehicle associated with vehicle device 310, which may have location requirements 1104 and location insurance suggestions 1106. Insurance review request 1100 may also include user information 1108 (e.g., user age, height, weight, health, gender, driving history, etc.) and adjustment 1110, which may include all available insurance coverage adjustments to provide vehicle device 310, which includes at least available adjustments 1010.

Insurance adjustment module 342 may determine adjustments 1110 using available insurance plans 1112. Available insurance plans 1112 may include insurance plans/policies available with at least one insurance provider. Available insurance plans 1112 may be accrued from the insurance provider(s) or may include plans submitted by the insurance provider(s). Insurance adjustment module 342 may also utilize insured users 1114 to determine information, such as current insurance coverage 322 and user information 1108. Insurance adjustment module 342 may also utilize insurance information 1116 to determine adjustments 1110, where insurance information 1116 may include locations 1118 (e.g., location specific insurance information, such as weather, local traffic, safety concerns, local legal requirements, etc.), user parameters 1120 (e.g., insurance requirements based on height, age, weight, gender, etc.), and vehicle parameters 1122 (e.g., insurance requirements for vehicle type/make/model/year, cargo transported by the vehicle, passengers in the vehicle, etc.).

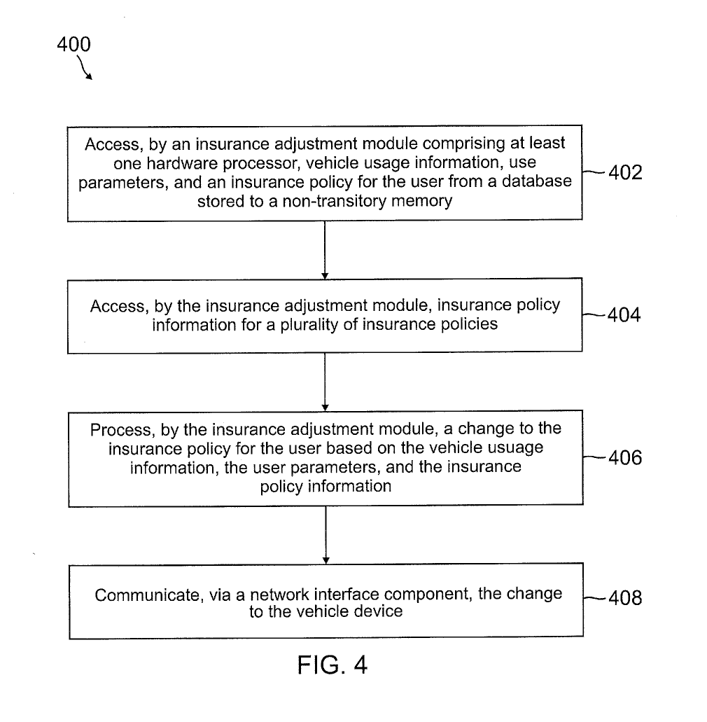

FIG. 4 is a flowchart of an exemplary process for detection of users and vehicle usage for variable insurance terms, according to an embodiment. Note that one or more steps, processes, and methods described herein may be omitted, performed in a different sequence, or combined as desired or appropriate.

At step 402, vehicle usage information, user parameters, and an insurance policy for the user is accessed, by an insurance adjustment module comprising at least one hardware processor, from a database stored to a non-transitory memory. The vehicle usage information may comprise at least one of a location of travel for the vehicle, a speed of travel for the vehicle, a number of passengers in the vehicle, an age of the passengers in the vehicle, a health state of at least one of the first user and the passengers in the vehicle, cargo transported by the vehicle, a driving history of the user, expected repairs during use of the vehicle by the user, theft information for the location of travel for the vehicle, vehicle information for the vehicle, additional drivers of the vehicle associated with the first user, and legal defense requirements for use of the vehicle by the user. The insurance policy may correspond to current insurance coverage information, which may comprise at least one of a current deductible amount, a current property damage coverage amount, a current medical coverage amount, a coverage amount of associated drivers of the vehicle, a limit on personal coverage, a limit on third party coverage, an insured vehicle, and a type of insured vehicle.

The vehicle usage information may be tracked using at least one of a device sensor, an input interface, and a communication module. A device associated with the vehicle may communicate the at least one first usage factor to the insurance adjustment module on detection of the user in the vehicle, wherein the device detects the first user in the vehicle using a short range communication protocol between a communication device for the first user and the device, and wherein the short range communication protocol comprises one of near field communication, radio communication, infrared communication, Bluetooth communication, Bluetooth Low Energy (BLE) communication, LTE Direct communication, and WiFi communication. The device may also communicate the at least one first usage factor to the insurance adjustment module on detection of the first user in the vehicle, wherein the device detects the first user in the vehicle using at least one of a weight sensor in the vehicle, a login of the first user on an onboard computing system, an RFID tag, a radio or infrared communication from a key unit, and a biometric of the first user. The user parameters may comprise an identity of the user, as well as user statistics, parameters, etc., such as height, weight, age, gender, health, etc., and user driving history or other information that may affect at least one insurance term for an insurance policy.

Insurance policy information for a plurality of insurance policies is accessed, by the insurance adjustment module, at step 404. At step 406, a change/adjustment to the insurance policy is determined, by the insurance adjustment module, based on the vehicle usage information, user parameters, and the insurance policy information. Thus, at step 408, the change/adjustment is communicated, via a network interface component to the vehicle device (e.g., a device associated with the vehicle). The device may comprise one of a communication device for the user, a vehicle console device in the vehicle, and a heads up display device in the vehicle. The change/adjustment may comprise a new insurance policy in certain embodiments, and/or an adjustment to present insurance coverage. In various embodiments, the insurance adjustment module may receive an acceptance of the change and initiate the change for the user. Additionally, a second user associated with the vehicle (e.g., an owner or renter of the vehicle to the user) may be alerted of the user's decision to accept or decline the change/adjustment to insurance coverage. The second user may also be alerted of the change/adjustment and any further changes or adjustments communicated to the first user for use with insuring the vehicle.

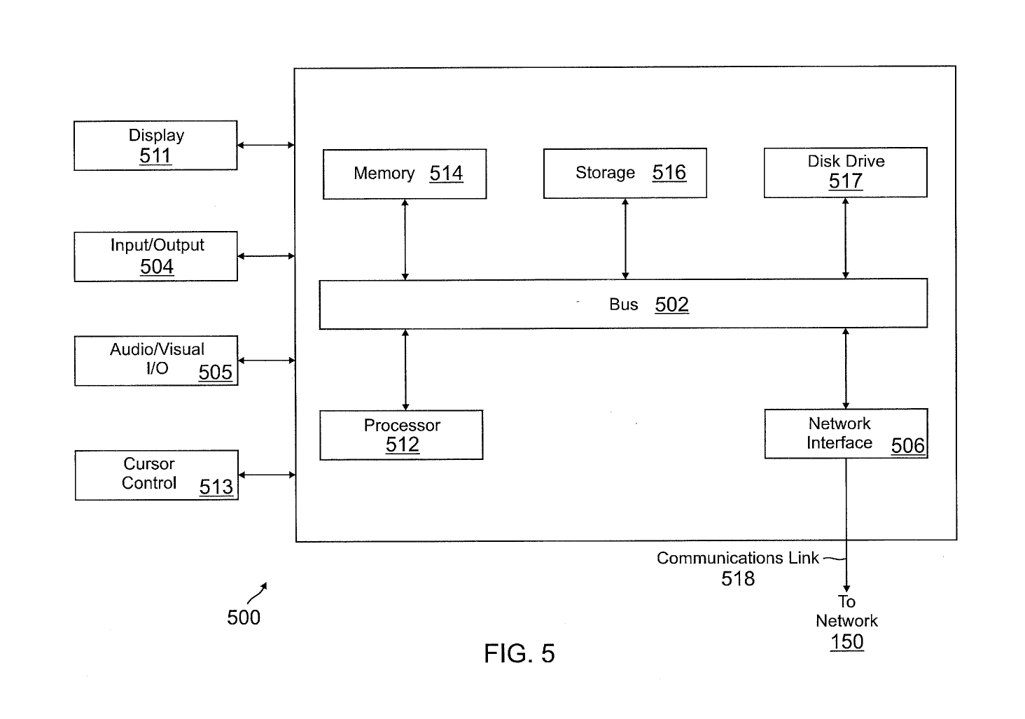

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
an insurance adjustment module comprising at least one hardware processor that accesses at least one first usage factor of a vehicle by a first user, accesses first user information and current insurance coverage information for the first user with the vehicle, accesses available insurance policy information comprising a plurality of available insurance policies, and determines an adjustment of the current insurance coverage information using the at least one first usage factor, the first user information, and the available insurance policy information;
a database, stored to a non-transitory memory, comprising the at least one first usage factor, the first user information, and the available insurance policy information; and
a network interface component that receives the at least one first usage factor from a device associated with at least one of the user and the vehicle and communicates the adjustment to the device.

2. The system of claim 1, wherein the at least one first usage factor comprises at least one of a location of travel for the vehicle, a speed of travel for the vehicle, a number of passengers in the vehicle, an age of the passengers in the vehicle, a health state of at least one of the first user and the passengers in the vehicle, cargo transported by the vehicle, a driving history of the user, expected repairs during use of the vehicle by the user, theft information for the location of travel for the vehicle, vehicle information for the vehicle, additional drivers of the vehicle associated with the first user, and legal defense requirements for use of the vehicle by the user.

3. The system of claim 1, wherein the current insurance coverage information comprises at least one of a current deductible amount, a current property damage coverage amount, a current medical coverage amount, a coverage amount of associated drivers of the vehicle, a limit on personal coverage, a limit on third party coverage, an insured vehicle, and a type of insured vehicle.

4. The system of claim 1, wherein a second user owns the vehicle, wherein the current insurance coverage information for the first user with the vehicle comprises no insurance policy for the first user with the vehicle, and wherein the adjustment comprises an offer to activate of a first insurance policy from the plurality of available insurance policies.

5. The system of claim 4, wherein the insurance adjustment module further generates an alert to the second user of the adjustment, and wherein the network interface component communicates the alert to a communication device associated with the second user.

6. The system of claim 4, wherein the network interface component further receives an acceptance of the offer in the adjustment from one of the first user and the second user associated with the vehicle, and wherein the insurance adjustment module further activates the first insurance policy based on the acceptance.

7. The system of claim 4, wherein the network interface component further receives a rejection of the offer in the adjustment from the first user, wherein the insurance adjustment module further determines a second insurance policy from the plurality of available insurance policies for the first user using the at least one first usage factor, the first user information, and the available insurance policy information, and wherein the network interface component further communicates the second insurance policy to the device.

8. The system of claim 7, wherein the insurance adjustment module further generates an alert to the second user of the rejection, and wherein the network interface component communicates the alert to a communication device associated with the second user.

9. The system of claim 4, wherein the second user rents the vehicle to the first user, and wherein the first insurance policy comprises a rental insurance policy for the vehicle for a time period of rental of the vehicle by the first user.

10. The system of claim 1, wherein the adjustment is based on at least one of a location for the vehicle, a driver history of the first user, a first law associated with use the vehicle, a second law associated with the location for the vehicle, and a third law associated with the first user.

11. The system of claim 1, wherein the insurance adjustment module determines the adjustment to maximize at least one of an insurance coverage for the first user with the vehicle and a cost savings for payments of the insurance coverage for the first user.

12. The system of claim 1, wherein the device communicates the at least one first usage factor to the insurance adjustment module on detection of the first user in the vehicle, wherein the device detects the first user in the vehicle using a short range communication protocol between a communication device for the first user and the device, and wherein the short range communication protocol comprises one of near field communication, radio communication, infrared communication, Bluetooth communication, Bluetooth Low Energy (BLE) communication, LTE Direct communication, and WiFi communication.

13. The system of claim 1, wherein the device communicates the at least one first usage factor to the insurance adjustment module on detection of the first user in the vehicle, and wherein the device detects the first user in the vehicle using at least one of a weight sensor in the vehicle, a login of the first user on an onboard computing system, an RFID tag, a radio or infrared communication from a key unit, and a biometric of the first user.

14. A method comprising:
receiving, by an insurance adjustment module comprising at least one hardware processor, vehicle usage information of a vehicle by a user from a device associated with at least one of the user and the vehicle;
accessing, by the insurance adjustment module, user parameters and a first insurance policy for the user from a database stored to a non-transitory memory;
accessing, by the insurance adjustment module, insurance policy information for a plurality of insurance policies from the database;
determining, by the insurance adjustment module, an insurance policy adjustment to the first insurance policy for the user using on the vehicle usage information, the user parameters, and the insurance policy information; and
communicating, via a network interface component, the change to the device.

15. The method of claim 14, wherein prior to the receiving, by the insurance adjustment module, the at least one usage factor, the method further comprises:
receiving, by the insurance adjustment module, a request for the insurance policy adjustment; and
requesting, by the insurance adjustment module, the vehicle usage information of the vehicle by the user.

16. The method of claim 14, wherein the device associated with the at least one of the user and the vehicle comprises one of a communication device for the user, a vehicle console device in the vehicle, and a heads up display device in the vehicle.

17. The method of claim 16, wherein the device tracks the vehicle usage information using at least one of a device sensor, an input interface, and a communication module.

18. The method of claim 14, wherein the insurance policy adjustment comprises a cancellation of the first insurance policy, and wherein the method further comprises:
receiving, via the network interface component, a first acceptance of the cancellation;
determining, by the insurance adjustment module, a second insurance policy for use of the vehicle by the user using on the vehicle usage information, the user parameters, and the insurance policy information; and
communicating, by the insurance adjustment module, the second insurance policy to the device.

19. The method of claim 18 further comprising:
receiving, via the network interface component, a second acceptance of the second insurance policy; and
processing, by the insurance adjustment module, the second acceptance to initiate the second insurance policy for use of the vehicle by the user.

20. A non-transitory computer-readable medium comprising executable modules which, in response to execution by a computer system, cause the computer system to perform a method comprising:
receiving, by an insurance adjustment module comprising at least one hardware processor, a request to adjust an insurance policy for a vehicle from a network interface component;
accessing, by the insurance adjustment module, at least one parameter associated with one of the vehicle and the user from a database stored to a non-transitory memory;
accessing, by the insurance adjustment module, insurance policy information for a plurality of insurance policies from the database;
determining, by the insurance adjustment module, at least one policy adjustment to the insurance policy using the request, the at least one parameter, and the insurance policy information; and
communicating, via a network interface component, the at least one policy adjustment to a device associated with at least one of the user and the vehicle.
